(19) United States
(12) Patent Application Publication
(10) Pub. No.: US 2019/0218854 A1
(43) Pub. Date: Jul. 18, 2019

(54) RETRACTABLE GATE

(71) Applicant: SUMMER INFANT (USA), INC., Woonsocket, RI (US)

(72) Inventors: Michael Thomas Fusco, Greenville, RI (US); Chris Briden, Woonsocket, RI (US)

(21) Appl. No.: 16/248,289

(22) Filed: Jan. 15, 2019

Related U.S. Application Data
(60) Provisional application No. 62/617,887, filed on Jan. 16, 2018.

(51) Int. Cl. E06B 9/08

(52) U.S. Cl. CPC E06B 9/08; E06B 2009/002

(57) ABSTRACT

A method and apparatus for a retractable gate. A retractable gate includes a main case housing a retractable fabric panel, the fabric panel including a carrier bar positioned along an edge opposing the main case, an attachment bracket, the carrier bar on the fabric panel removably attached to either side of an attachment bracket, and a portion of the fabric

### CROSS REFERENCE TO RELATED APPLICATIONS

This application claims benefit from U.S. Provisional Patent Application Ser. No. 62/617887, filed Jan. 16, 2018, which is incorporated by reference in its entirety.

### STATEMENT REGARDING GOVERNMENT INTEREST

None.

### BACKGROUND OF THE INVENTION

The present invention relates generally to household removable gates, and more particularly to a retractable gate.

There is often a need to restrict the movement of young children or domestic pets throughout a dwelling, especially in situations where potential hazards may exist. Childproof gates have traditionally been used to corral children into areas where they may safely be left or in which they can be supervised. These gates have taken many forms including collapsible wooden slats or solid pieces slid into retaining channels attached to each doorjamb. Such devices are unwieldy and may themselves present pinching hazards as they are collapsed.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In general, in one aspect, the invention features a retractable gate including a main case housing a retractable fabric panel, the fabric panel including a carrier bar positioned along an edge opposing the main case, an attachment bracket, the carrier bar on the fabric panel removably attached to either side of an attachment bracket, and a portion of the fabric panel including a series of grip materials.

In another aspect, the invention features a retractable gate for removably attaching to doorways including a main case housing a retractable fabric panel, the main case including a two or more external studs for attachment to one side of an external frame, the fabric panel including a carrier bar positioned along an edge opposing the main case, a portion of a first and second side of the fabric panel including a series of grip materials, an attachment bracket, the carrier bar on the fabric panel removably attached to an attachment bracket, the attachment bracket including two or more external studs for attachment to an opposite side of the external frame, and the main case including a spool for storing the fabric panel, and a lengthwise slot to provide an opening for the fabric panel.

Embodiments of the invention may have one or more of the following advantages.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIG. 1 is a view of an exemplary retractable gate according to the invention.

FIG. 2 is a top view of the retractable gate of FIG. 1.

FIG. 3 is a perspective view of the retractable gate of FIG. 1.

FIG. 4 is a rotated view of the retractable gate of FIG. 1.

FIG. 5 is a view of the a material attached to a lower portion of the fabric panel of the retractable gate of FIG. 1.

FIG. 6 is a section view from above through a housing of the retractable gate of FIG. 1.

FIG. 7 is a magnified view of the slot of FIG. 6.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

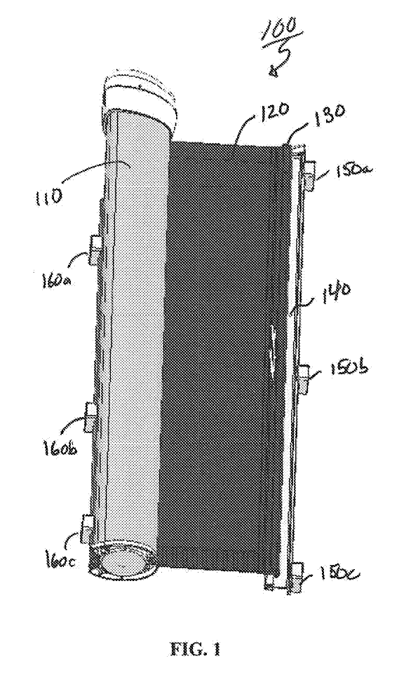

As shown in FIG. 1, an exemplary retractable gate 100 includes a main case 110 (also referred to as a housing), a fabric panel 120 and a carrier bar 130. The carrier bar 130 on the fabric panel 120 is removably attached to an attachment bracket 140. In one implementation, the attachment bracket 140 includes studs 150a, 150b, 150c that are used to secure the attachment bracket 140 to one side of a door frame (not shown). In one implementation, the main case 110 includes studs 160a, 160b, 160c, attached to a bracket (not shown), which are used to secure the main case 110 to an opposite side of the door frame.

The fabric panel 120 is removably housed in the in the main case 110. When the main case 110 and attachment bracket 140 are secured to opposite ends of the door frame, the fabric panel 120 may be pulled from the main case 110 and its carrier bar 130 secured to the attachment bracket 140. The fabric panel 120 will be drawn across a door step (not shown). Detaching the carrier bar 130 from the attachment bracket 140 enables the fabric panel 120 to be drawn back into the main case 110.

In one embodiment the main case 110 and the attachment bracket 140 are constructed of aluminum. In other embodiments, the main case 110 and the attachment bracket 140 are constructed of other materials, such as nylon for the attachment bracket 140, for example. In still other embodiments, the attachment bracket 140 is constructed of other rigid materials.

In one embodiment, a taper is added on a lower portion of the attachment 140 bracket to provide a consistent alignment with the carrier bar 130.

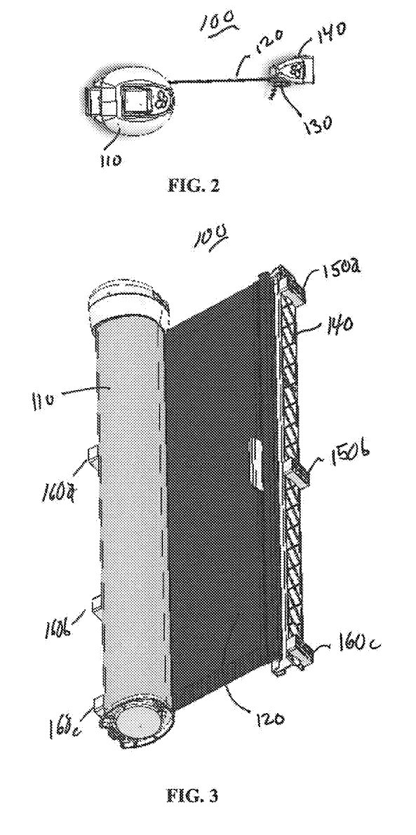

FIG. 2 illustrates a top view of the retractable gate 100 in which the fabric panel 120 is extended from the main case 110 and secured to a door frame by attaching the carrier bar 130 to the attachment bracket 140.

FIG. 3 illustrates a perspective view of the retractable gate 100.

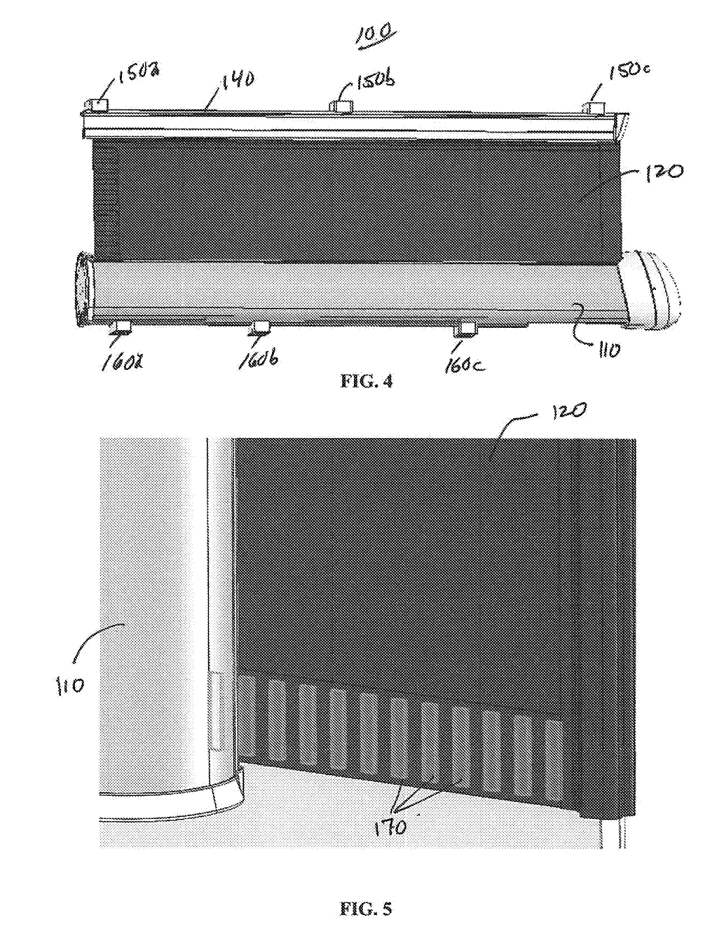

FIG. 4 illustrates a rotated view of the retractable gate 100.

Referring now to FIG. 5, a lower portion of the fabric panel 120 includes a series of raised grip material 170 permanently attached. Although the raised grip material 170 is illustrated attached on one side of the fabric panel 120, in a preferred embodiment, the raised grip material 170 is permanently attached to lower portions of both sides of the fabric panel 120. The raised grip material 170 aids stability of the retractable gate 100 and creates resistance against items slipping under from one side to the other when the fabric panel 120 is extended or withdrawn from the main case 110.

In other implementations, any gripping material may be added at any part of the fabric of the gate, and even include material that overlays or constitutes the “fabric” portion itself.

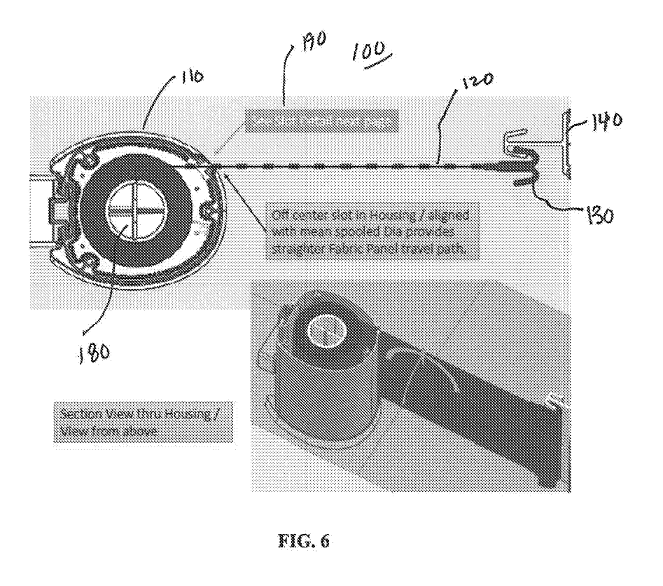

FIG. 6 illustrates a section view from above through the housing 110 of the retractable gate 100. The housing 110 includes a spool 180 around which the fabric panel 120 is stored. The housing 110 includes an off center slot 190 traveling a length of the housing 110. The off center slot 190 is aligned with a mean diameter of the spool 180 and provides a straight travel of the fabric panel 120 as it is drawn out and in of the house 110 and the spool.

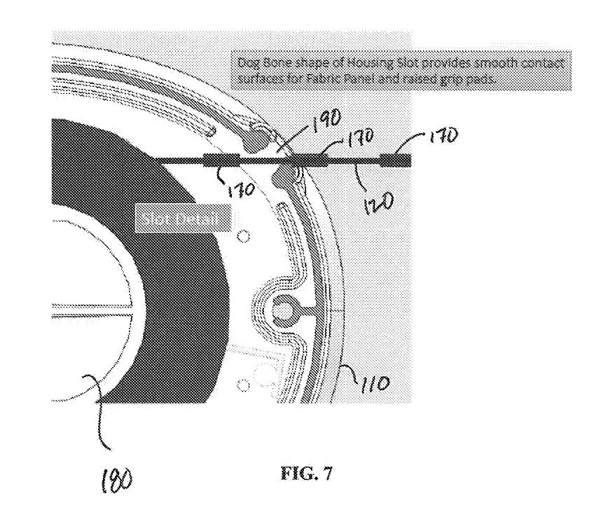

As shown in FIG. 7, the off center slot 190 is shaped like a dog bone to provide smooth contact surfaces for the fabric panel 120 and raised grip material 170.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A retractable gate comprising:
a main case housing a retractable fabric panel, the fabric panel including a carrier bar positioned along an edge opposing the main case;
an attachment bracket, the carrier bar on the fabric panel removably attached to either side of an attachment bracket; and
a portion of the fabric panel including a section of grip material.

2. The retractable gate of claim 1 further comprising a portion of a second side of the fabric panel including a series of grip materials.

3. The retractable gate of claim 1 wherein the housing includes a two or more external studs for attachment to one side of an external frame.

4. The retractable gate of claim 3 wherein the attachment bracket includes a two or more external studs for attachment to an opposite side of the external frame.

5. The retractable gate of claim 1 wherein a main case comprises:
a spool for storing the fabric panel; and
a lengthwise slot to provide an opening for the fabric panel.

6. The retractable gate of claim 5 wherein the lengthwise slot is aligned with a mean diameter of the spool.

7. The retractable gate of claim 2 wherein the lengthwise slot has a dog bone shape to enable smooth contact of the fabric panel and the series of grip materials.

8. The retractable gate of claim 1 wherein the main case is constructed of aluminum.

9. The retractable gate of claim 1 wherein the main case is constructed of aluminum and the attachment bracket is constructed of nylon.

10. A retractable gate for removably attaching to doorways comprising:
a main case housing a retractable fabric panel, the main case including a two or more external studs for attachment to one side of an external frame, the fabric panel including a carrier bar positioned along an edge opposing the main case, a portion of a first and second side of the fabric panel including a section of grip material;
an attachment bracket, the carrier bar on the fabric panel removably attached to an attachment bracket, the attachment bracket including two or more external studs for attachment to an opposite side of the external frame; and
the main case comprising:
a spool for storing the fabric panel; and
a lengthwise slot to provide an opening for the fabric panel.

11. The retractable gate of claim 10 wherein the lengthwise slot is aligned with a mean diameter of the spool.

12. The retractable gate of claim 11 wherein the lengthwise slot has a dog bone shape to enable smooth contact of the fabric panel and the series of grip materials.

13. The retractable gate of claim 10 wherein the main case is constructed of aluminum.

14. The retractable gate of claim 10 wherein the main case is constructed of aluminum and the attachment bracket is constructed of nylon.
